(19) United States
(12) Patent Application Publication
(10) Pub. No.: US 2011/0212238 A1
(43) Pub. Date: Sep. 1, 2011

(54) Apparatus And Process For Tempering Chocolate

(76) Inventors: Mehran Rose, Hohenbrunn (DE); Uwe Riedel, Inzlingen (DE); Konstantinos Paggios, Munchen (DE); Martin Richard Thiele, Holzkirchen (DE)

(21) Appl. No.: 12/917,207

(22) Filed: Nov. 1, 2010

(30) Foreign Application Priority Data
Nov. 6, 2009 (EP) 09175246

(51) Int. Cl. A23G 1/10; A23G 1/30

(52) U.S. Cl. 426/519; 99/348

(57) ABSTRACT

A tank for tempering cocoa butter containing mass is provided. This tank, which is equipped with a scraper and an impeller, is characterized in that the impeller induces a downward current of the cocoa butter containing mass in the tank. The tank allows for tempering cocoa butter containing mass in a single step wherein the temperature is decreased from an initial temperature of about 53° C. to about 57° C. to a final temperature of about 30° C. to about 32° C.

### CROSS-REFERENCE TO RELATED APPLICATION

This application claims priority from European Patent Application Number EP 09175246, filed Nov. 6, 2009, which is hereby incorporated herein by reference in its entirety.

### FIELD

The present invention relates to an improved process for tempering cocoa butter containing mass, including cocoa butter, chocolate, cocoa butter equivalent, cocoa butter substitute and replacers, mixtures of cocoa butter with anhydrous milk fat and/or cocoa butter improver, or mixture of cocoa butter with another fat, preferably a filling fat. In particular, it relates to a one-step process for tempering.

### BACKGROUND

The flavour and mouthfeel of chocolate and chocolate-like masses results from the combination of the components as well as the process of manufacture. Chocolate contains solid particles dispersed throughout a fat matrix derived mainly from cocoa butter and milk fat.

Cocoa butter which typically is the predominant fat in chocolate is a polymorphic material. I.e. it crystallizes in several different crystal packing configurations (Wille and Lutton “Polymorphism of Cocoa Butter,” Journal of the American Oil Chemists' Society, Vol. 43 (1966), pages 491-496). Generally, six different polymorphs are recognized which are set out in Table 1 below.

TABLE 1

| | Structure | Approximate | Reported Melting |
|---|---|---|---|
| Polymorph | Type | Melting Point [° C.] | Point [° C.] |
| I | partly β′ | 0-5 | 0-18 |
| II | α | 16-18 | 17-24 |
| III | β′ | 23-36 | 20-26 |
| IV | β′ | 26-28 | 25-28 |
| V | β | 30-33 | 30-35 |
| VI | β | 33-36 | 32-36 |

Forms I and II are produced, for example, by rapidly cooling melted untempered chocolate to low temperatures and are very unstable due to their low melting points. Forms III and IV melt at higher temperatures than Forms I and II but are not the most desirous forms for confectionery manufacture. Forms V and VI are the most stable forms of cocoa butter. It is desirable to have Form V as the predominant form in a well-tempered chocolate. Form V transforms slowly into Form VI after a period of time. Form VI is believed to be the transformation result of Form V, and cannot be produced in the conventional batch or continuous tempering processes. This crystal form is the most stable polymorphic form and cannot isothermally be transformed into other lower melting crystal forms. Products made with Form VI have the following characteristics:
better heat stability,
lower tendency for fat bloom, and
better firmness/snap, gloss.
   Accordingly, chocolate processing is strongly linked to the crystallization and polymorphic behaviour of the fat phase. Before chocolate can be satisfactorily processed from liquid to solid using conventional methods, it must be tempered after which it is gently cooled to form a set chocolate having a stable fat phase.

The conventional process for tempering chocolate has been developed by Walter Kreuter (U.S. Pat. No. 4,238,516) and comprises the following steps:
heating the chocolate mass to a first temperature of e.g. 45-60° C. thereby melting the cocoa butter fats in the mass;
cooling the mass at a mild cooling rate to a second temperature of e.g. 28-29° C., thereby initiating pre-crystallization of the mass;
mildly heating the mass to a third temperature of e.g. 33-34° C. at which pre-crystallization is complete.

Chocolate tempering is commonly executed in automatic tempering machines which are available e.g. from SOLLICH® and AASTED®. During tempering, the liquid chocolate stream is constantly agitated while being super cooled to the fat crystallization temperature of usually 27-31° C. Generally, these tempering machines have various zones with heating and cooling possibility and are disclosed e.g. in EP 0 237 168, EP 0 654 222, DE 39 13 941, EP 0 289 849, EP 0 394 721, and EP 0 339 129.

In particular, EP 0 237 168 discloses a method of tempering edible fat compositions such as chocolate which involve controlling the temperature of the composition to a predetermined temperature, passing the temperature-controlled composition continuously through a heat exchanger, monitoring the consistency of the composition being discharged from the heat exchanger and using this to control the cooling of the composition in the heat exchanger. Monitoring of the consistency may e.g. be effected by monitoring the pressure difference across the heat exchanger using pressure transducers.

However, the prior art method are unsatisfactory because they require complicated machineries.

Moreover, it was not possible to produce Form VI from the molten cocoa butter containing mass under the static conditions of the prior art processes. In the prior art, transition to Form VI could only be achieved through the memory effect of cocoa butter or seeding process such as described in e.g. WO 01/06863 and WO 00/72695.

EP 0 525 524 discloses a method for making Form VI crystals by a thermal treatment which entails cooling and heating. The cooling process is far stronger than in the previous methods, and would cause a solidification of the cocoa containing mass under static conditions. This solidification is prevented by conducting the method in a small continuous flow container with a volume of 0.25-10 litres under high shear. The method uses single shaft mixing, and the rotational speed is controlled through rpm variation. This shearing operation has a greater effect in the longitudinal direction than in the radial one.

However, it was previously not possible to design the tempering apparatus in a way so as to ensure a residence time, mixing performance which allows for providing Form VI crystals in one step and which can be conducted in larger vessels.

### SUMMARY

Surprisingly, the present inventors now discovered that by conducting the tempering process in a specific tank, the tempering process can be simplified and Form VI crystals can be obtained. In addition, the process of the invention results in a higher quantity of crystals than the prior art process, i.e. approximately more than about 1% and up to about 20% as compared to 0.5-1%. This results in a chocolate which is more stable and is less prone to fat bloom.

In particular, the present invention is directed to a tank (1) for tempering chocolate containing mass, which is equipped with a scraper (2) and an impeller (5), characterized in that the impeller (5) induces a downward current of the cocoa butter containing mass in the tank.

Further, the present invention relates to a process for tempering cocoa butter containing mass characterized in that the temperature is decreased from an initial temperature of about 53° C. to about 57° C. to a final temperature of about 30° C. to about 34° C. in a single step.

### BRIEF DESCRIPTION OF THE DRAWINGS

FIG. 1 shows one embodiment of the tank according to the invention.

FIG. 2 shows a cross section of the tank, including the scraper and the impeller.

FIG. 3 shows a particularly preferred shape for the impeller used in the present invention.

FIG. 4 shows a comparison of the temperature profile according the invention and the one of the prior art.

FIG. 5 shows an XRPD analysis of a chocolate sample obtained with the process of the invention.

### DETAILED DESCRIPTION

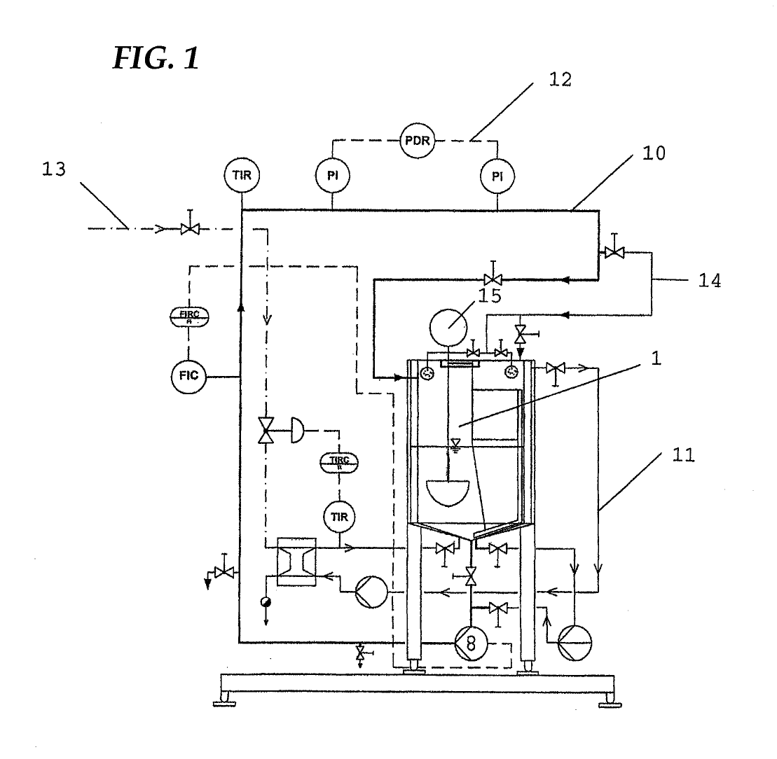

The present invention relates to a tank for tempering cocoa butter containing mass, in particular chocolate, which includes a scraper and an impeller. One exemplary embodiment of a tank according to the invention is depicted in FIG. 1.

The tank 1 is equipped with a multi shaft mixer including a scraper 2 and an impeller 5. The scraper has one arm or more, and preferably 3 arms. The impeller 5 generally has one or more blades, preferably 4 blades.

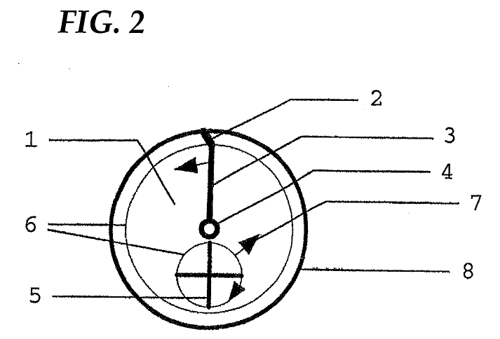

A cross-sectional view of the tank 1 which shows the arrangement of the scraper 2 and the impeller 5 is depicted in FIG. 2. The scraper 2 and the impeller 5 rotate in the direction of the arrows 7. The spheres of influence 6 of the scraper 2 and the impeller 5 are also indicated in FIG. 2.

The impeller 5 is designed so as to induce a downward current in the cocoa butter containing mass. The specific design of the impeller provides high rotational speed through 3-dimensional agitation. This, in turn, allows for a uniform control of the temperature in the tank and for one-step tempering. Further, it is assumed that the specific tempering process of the present invention results in Form VI crystals of cocoa butter.

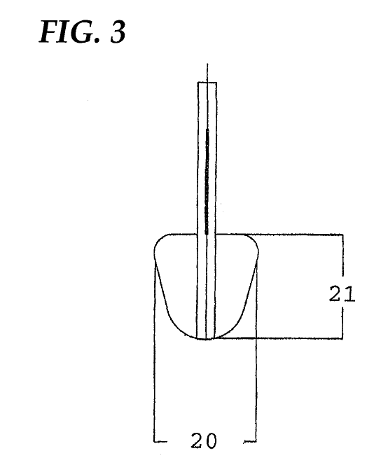

In a preferred embodiment of the impeller, the downward current in the cocoa butter containing mass is induced by a section of the blade(s) wherein the width decreases in the downward direction of the tank. A particularly preferred shape of the impeller is shown in FIG. 3.

In a particularly preferred embodiment, the tank 1 is equipped with a pipe for product circulation 10. A device for measuring the pressure 12 may be installed in this pipe for product circulation 10. This configuration allows for measuring the pressure drop and thus the viscosity of the mass, thereby enabling the assessment of the crystallization state of the cocoa butter containing mass.

As shown in FIG. 1, the tank 1 is further fitted with different pipes for hot water circulation 11, steam 13 and CIP (cleaning-in-place) 14. Further it is equipped with a control and a temperature indicator.

The tank according to the present invention differs from tanks used in the prior art Kreuter process in that it has been specifically designed for keeping the temperature constant while providing high shearing functionality.

The tank of the present invention allow for adjusting the speed of the scraper 2 and the impeller 5 based on the required shear stress. In particular, the impeller speed may be about 22 rpm to about 114 rpm, and the scraper speed may be about 11 rpm to about 57 rpm with a proportional factor impeller to scraper of 2.

In a further embodiment, the present invention provides a process for tempering cocoa butter containing mass characterized in that the temperature is decreased from an initial temperature of about 53° C. to about 57° C. to a final temperature of about 30° C. to about 34° C., preferably a final temperature of about 30° C. to about 32° C., in a single step. In a preferred embodiment, the process of the present invention does not involve subsequent heating of the cocoa butter containing mass.

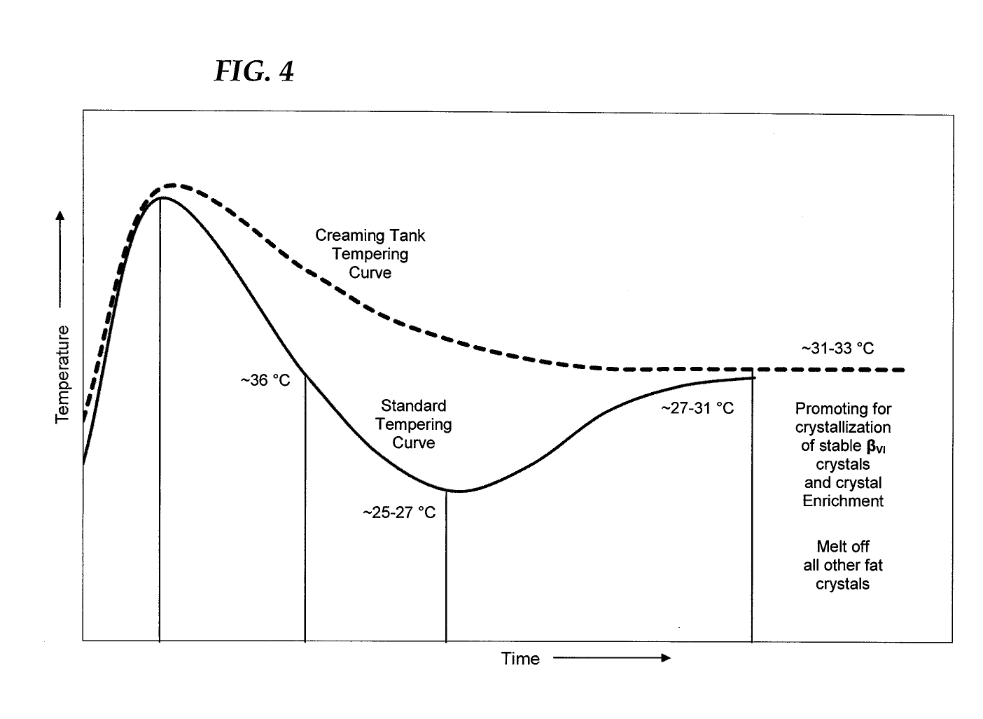

A preferred example of the temperature profile used in the process according to the present invention is depicted in FIG. 4 in comparison to the temperature profile of the prior art Kreuter process. It is derivable from FIG. 4 that the process of the present invention does not involve super cooling of the mass to a temperature lower than about 30° C. and the subsequent reheating of the mass.

Accordingly, the process of the invention allows for a shorter tempering procedure in comparison with the prior art. In contrast to the Kreuter process where the duration of the tempering process is dependent on the capacity of the apparatus and is typically within the range of about 3 to about 8 hours for an apparatus having a capacity of up to about 8000 kg, the time necessary for the tempering process of the present invention is independent of the batch size but depends on the temperature and the shear conditions.

The tank of the present invention preferably allows for continuous charging and discharging of the cocoa butter containing mass. In a particularly preferred embodiment, the process of the present invention is thus conducted in a continuous manner.

The cocoa containing mass which tempered in accordance with the present invention may be selected from cocoa butter, chocolate, cocoa butter equivalent, cocoa butter substitute and replacers. In addition, it may be a mixture of cocoa butter with anhydrous milk fat and/or cocoa butter improver, or a mixture of cocoa butter with another fat, preferably a filling fat.

In this respect, the term “cocoa butter” refers to the fat of the beans of the fruit of Theobroma cacao, 100% fat.

The term “cocoa butter equivalent” (CBE) refers to a vegetable fat composed of symmetrical 2-oleo-disaturated triacylglycerols of C16 and C18 fatty acids. They should be compatible with cocoa butter in the proportions normally used in chocolate.

The term “cocoa butter improver” (CBI) means a harder version of CBE due to the content of triacylglycerol containing stearic-oleic-stearic acids. It is used in chocolate formulations having a high content of milk fat or those meant for tropical climates.

The term “cocoa butter replacer” (CBR) refers to a nontempering fat differing in composition from cocoa butter and the tempering CBE and CBI. It is produced by fractionation and hydrogenation of oils rich in C16 and C18 fatty acids.

The term “cocoa butter substitute” (CBS) means a fat based on palm kernel and coconut oil, fractionated and hydrogenated. Because of its poor miscibility with cocoa butter, CBS is preferably used with low-fat cocoa powder (about 10-12% fat) only.

These definitions are in line with the Lexicon of Lipid Nutrition, Pure and Applied Chemistry, 2001, Vol. 73, No. 4, pages 685-744.

In addition, advantages and embodiments of the process and apparatus described herein are further illustrated by the following example; however, the particular conditions, materials and amounts thereof recited in the example, as well as other conditions and details, should not be construed to unduly limit this method. All percentages are by weight unless otherwise indicated.

### Example

Chocolate mass having the following composition was used:

| | |
|---|---|
| Sugar | 28% |
| Cocoa liquor | 42% |
| Cocoa butter | 22% |
| Cocoa powder | 8% |

During this experiment, the tank was operated with an impeller speed of about 114 rpm and a scraper speed of abut 57 rpm.

The chocolate mass was molten at a temperature of about 50-55° C. in warming cabinet about three days before trials. Liquid hot cocoa butter about 50-55° C. or hot chocolate was used to rinse the tank and warm-up the whole processing line.

Hot water was circulated in the insulated double-jacketed tank, thereby bringing the system to the desired operating temperature of about 55±2° C. The tank was filled with about 55±2° C. hot chocolate mass through accessible lid on top of tank. This hot chocolate mass was immediately agitated using the scraper and the impeller. During the processing time, the chocolate mass was circulated in the circulation pipe to measure the pressure drop.

The chocolate mass was cooled to about 31±1° C. with a constant rate of about 0.43° C./min during approximately 1 hour.

Using the sampling valve, approximately 1000 g hot chocolate was extracted into a specialist plastic bag for confectionary applications and then subsequently transferred into in moulds, having a temperature of about 30° C. After filling, the moulds were vibrated and placed in a cooling chamber having a temperature of about 4° C. for approximately 30 minutes. The resulting tablets were removed from the moulds and wrapped with foil. These samples were used for analysis.

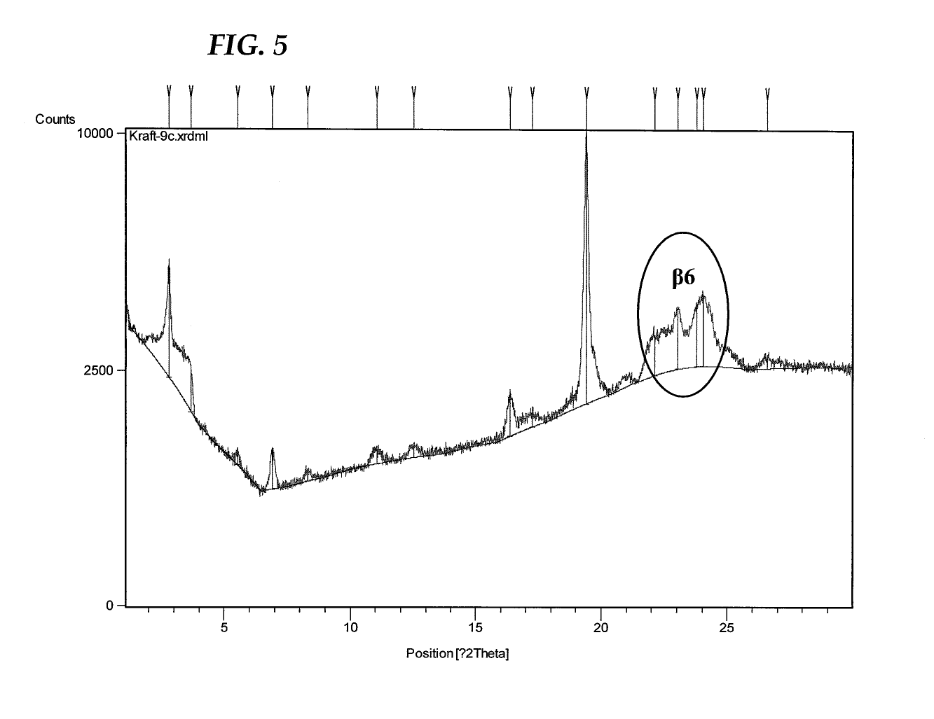

An XRPD analysis of the chocolate mass obtained is shown in FIG. 5. It is clearly derivable from the peaks at 2θ=22-25° that Form VI crystals were obtained in the mass.

It will be understood that various changes in the details, materials, and arrangements of the process, formulations, and ingredients thereof, which have been herein described and illustrated in order to explain the nature of the method and apparatus, may be made by those skilled in the art within the principle and scope of the embodied method and apparatus as expressed in the appended claims.

What is claimed is:

1. A tank for tempering chocolate containing mass, which is equipped with a scraper and an impeller, characterized in that the impeller induces a downward current of the cocoa butter containing mass in the tank.

2. The tank according to claim 1, characterized in that the impeller comprises one or more blades and a section wherein the width of the one or more blades decreases in the downward direction of the tank.

3. The tank according to claim 1, characterized in that it is further equipped with a pipe for product circulation.

4. The tank according to claim 3, wherein a device for measuring the pressure is installed in the pipe for product circulation.

5. A process for tempering a cocoa butter containing mass comprising:
introducing the cocoa butter containing mass into a tank, the tank comprising a scraper and an impeller; and
inducing a downward current of the cocoa butter containing mass in the tank.

6. The process according to claim 5, wherein the temperature is decreased from an initial temperature of about 53° C. to about 57° C. to a final temperature of about 30° C. to about 34° C. in a single step.

7. The process according to claim 5, which results in the formation of Form VI crystals.

8. The process according to claim 5, wherein the cocoa butter containing mass is selected from cocoa butter, chocolate, cocoa butter equivalent, cocoa butter substitute and replacers.

9. The process according to claim 5, wherein the cocoa butter containing mass is a mixture of cocoa butter with anhydrous milk fat and/or cocoa butter improver, or a mixture of cocoa butter with another fat, preferably a filling fat.

10. A process for tempering cocoa butter containing mass characterized in that the temperature is decreased from an initial temperature of about 53° C. to about 57° C. to a final temperature of about 30° C. to about 34° C. in a single step.

11. The process according to claim 10, which does not involve subsequent heating.

12. The process according to claim 10, which is conducted in a continuous manner.

13. The process according to claim 10, which is conducted in a tank comprising a scraper and an impeller, characterized in that the impeller induces a downward current of the cocoa butter containing mass in the tank.

14. The process according to claim 10, which results in the formation of Form VI crystals.

15. The process according to claim 10, wherein the cocoa butter containing mass is selected from cocoa butter, chocolate, cocoa butter equivalent, cocoa butter substitute and replacers.

16. The process according to claim 10, wherein the cocoa butter containing mass is a mixture of cocoa butter with anhydrous milk fat and/or cocoa butter improver, or a mixture of cocoa butter with another fat, preferably a filling fat.
